(19) United States
(12) Patent Application Publication
(10) Pub. No.: US 2011/0069391 A1
(43) Pub. Date: Mar. 24, 2011

(54) IMAGING DEVICE AND METHODS OF MANUFACTURING OF THE DEVICE

(76) Inventor: Haim Zvi Melman, (US)

(21) Appl. No.: 12/885,453

(22) Filed: Sep. 18, 2010

Related U.S. Application Data
(60) Provisional application No. 61/244,041, filed on Sep. 20, 2009.

(51) Int. Cl. G02B 5/28; B32B 3/10

(52) U.S. Cl. 359/589; 428/195.1

(57) ABSTRACT

A method and apparatus for producing low cost miniature images is provided. Modulated layers of materials over silicon substrate provide the shades of gray or colors needed to provide the perception of an image. Reflective characteristics as well as refractive characteristics of materials and modulated layers serve to produce the desired effects. Quasi-random geometries eliminate unwanted rainbow impressions. The resultant image is highly resistant to environmental conditions. Metal anodizing and coloring methods as well as metal anodizing interference thin layers methods are used to add more colors to the images. Relatively high-pitch patterns within the image produce secondary visual effects.

### FIELD OF THE INVENTION

The invention is related to the field of imaging and more particularly to the field of creating images using microelectronics and other surface treatment technologies.

### BACKGROUND OF THE INVENTION

Miniature images have been produced for decades using many techniques. Oil painting has been mastered by some artists to create images smaller even then 3 mm×3 mm. These images are hand-made and unsuitable for mass production. Photography is another technique useful for the creation of miniature images. With a typical resolution of 50 points/mm for photographic media, 2 mm×2 mm images can be created using mass production methods, thus reducing the cost per copy. Nevertheless, photographic materials are not durable and need additional production steps to encapsulate them and bring them to a form that is durable in a harsh environment that includes human handling and natural light radiation.

It is the purpose of the present invention to propose apparatus and method for manufacturing of low-cost, mass-production and highly durable miniature images. It is also the purpose of the present invention to propose the creation of artistic effects to the images to provide additional visual impressions associated with the miniature images.

### A SUMMARY OF THE INVENTION

In a preferred embodiment of the present invention, a layer of material such as aluminum is deposited on top of a silicon layer of a wafer. The aluminum layer is modulated at a relatively high spatial frequency to generate various shades of gray at lower spatial frequencies to generate a visual perception of an image for the human eye. In other embodiments of the invention, different materials are used to create different color impressions.

In yet another embodiment of the invention, the spatial modulation of the modulated layer is determined differently in each sub-area of the image to avoid the visual color impression resulting from interference produced by repetitive structural grids over large areas.

In another embodiment of the invention, layers of materials and thickness of layers are used to produce the desired color in the image.

The invention will be better understood in reference to the following Figures:

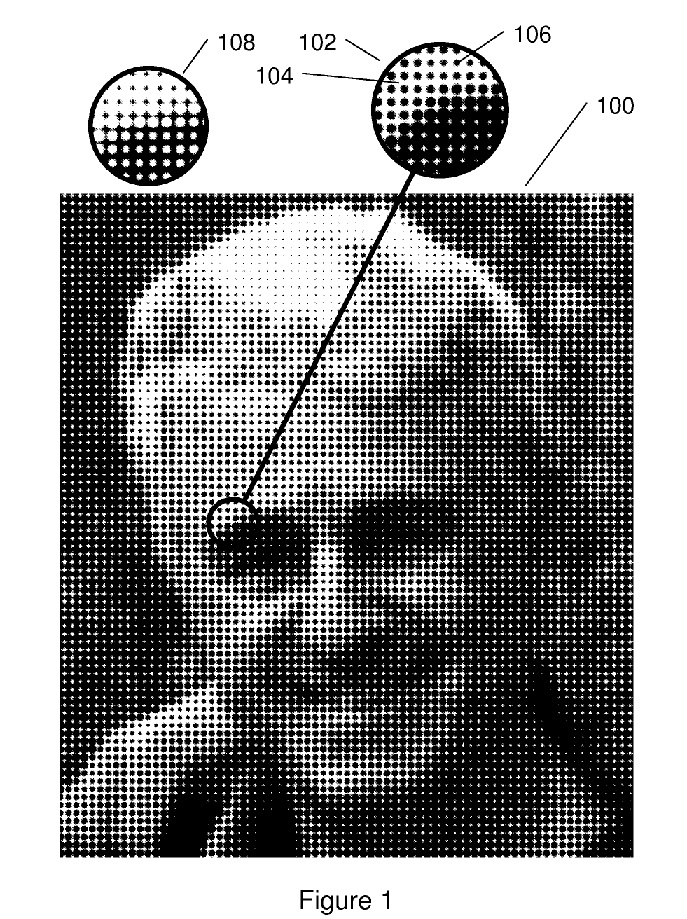

FIG. 1 is a schematic drawing of a silicon wafer substrate carrying a modulated layer of aluminum to configure the perception of a gray-scale image to a human observer.

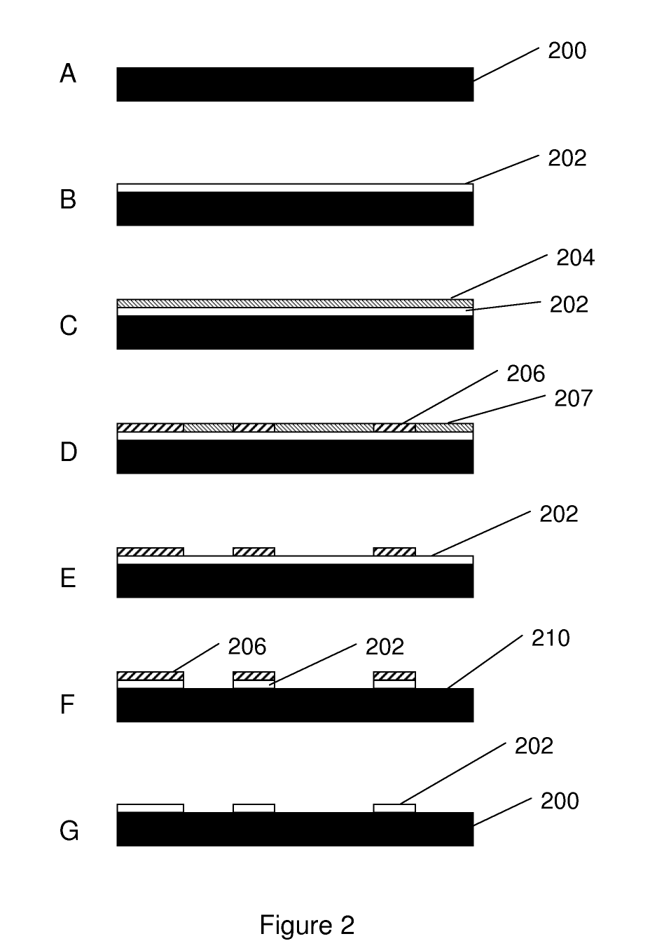

FIG. 2 illustrate typical process of modulating a layer of material deposited on a substrate to create a graphical item such as that of FIG. 1

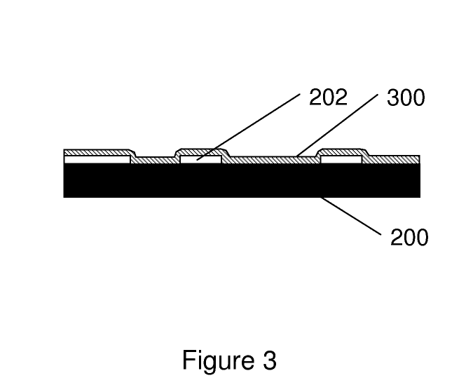

FIG. 3 illustrates a protective layer placed on top of the product of FIG. 2.

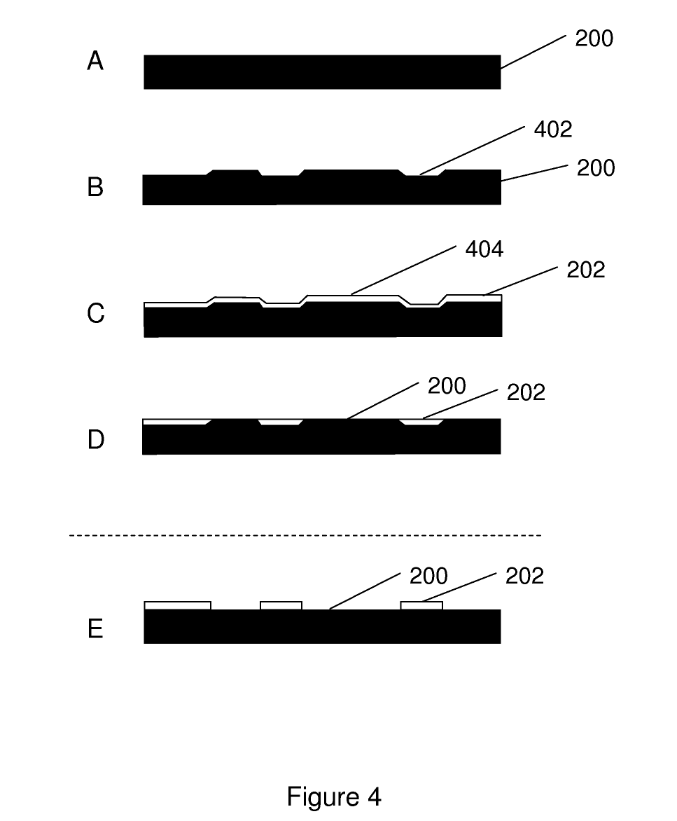

FIG. 4 illustrate another typical process of modulating a layer of material deposited on a substrate.

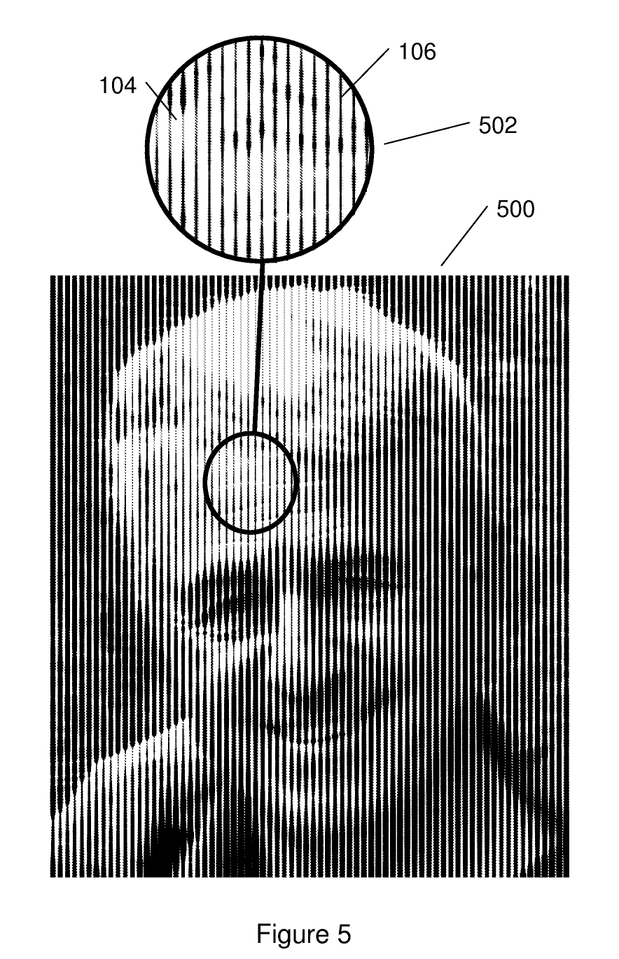

FIG. 5 is a schematic illustration of a silicon wafer substrate carrying a modulated layer of aluminum to configure the perception of a gray-scale image to a human eye, whereas the modulation geometry is different than the modulation geometry of FIG. 1.

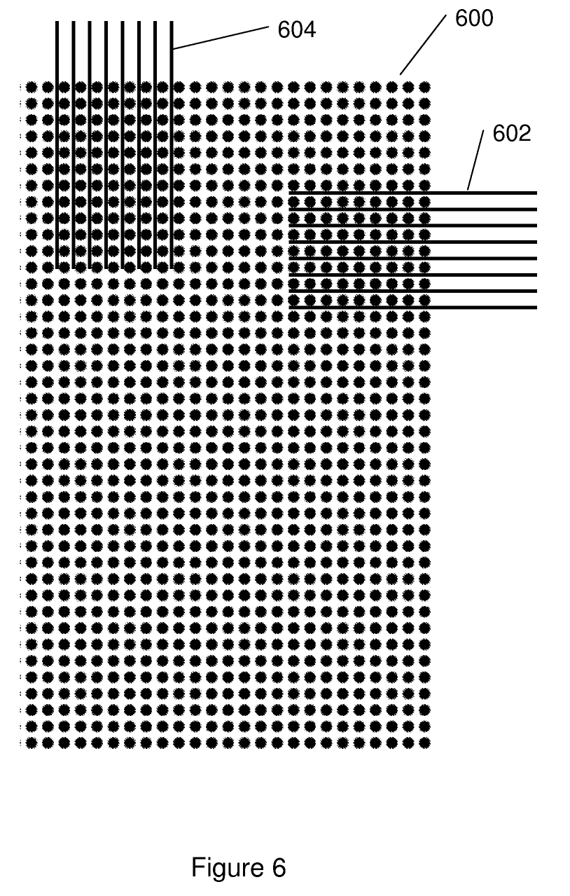

FIG. 6 demonstrates the repeating grid pattern of a modulation resulting in characteristics of interference and color modulation.

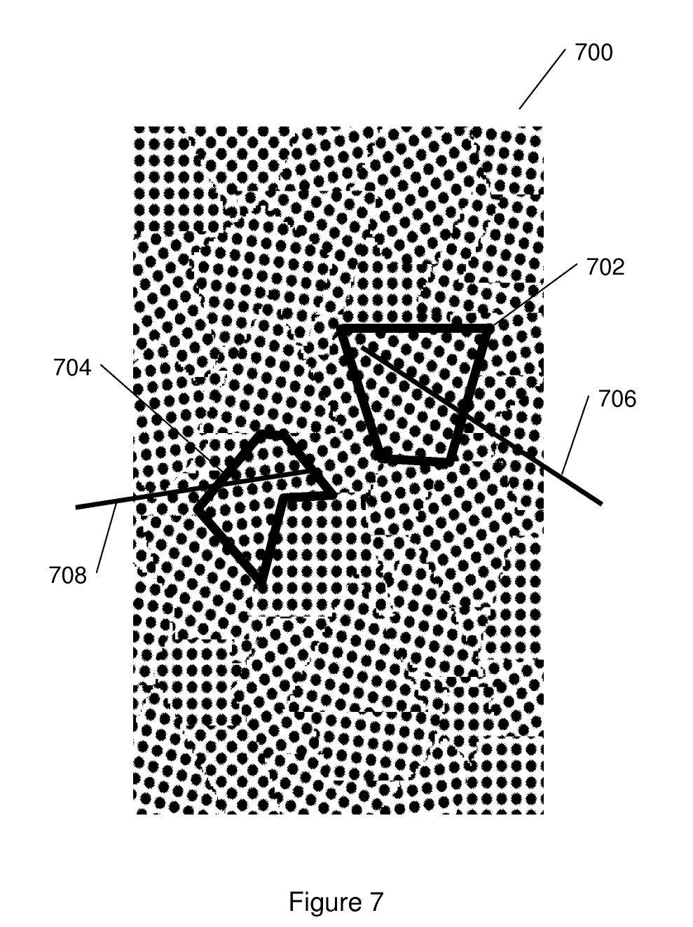

FIG. 7 illustrate a method to re-arrange the grid geometry to avoid perception, by an observer, of color modulations due to interference resulting from a repeating grid pattern.

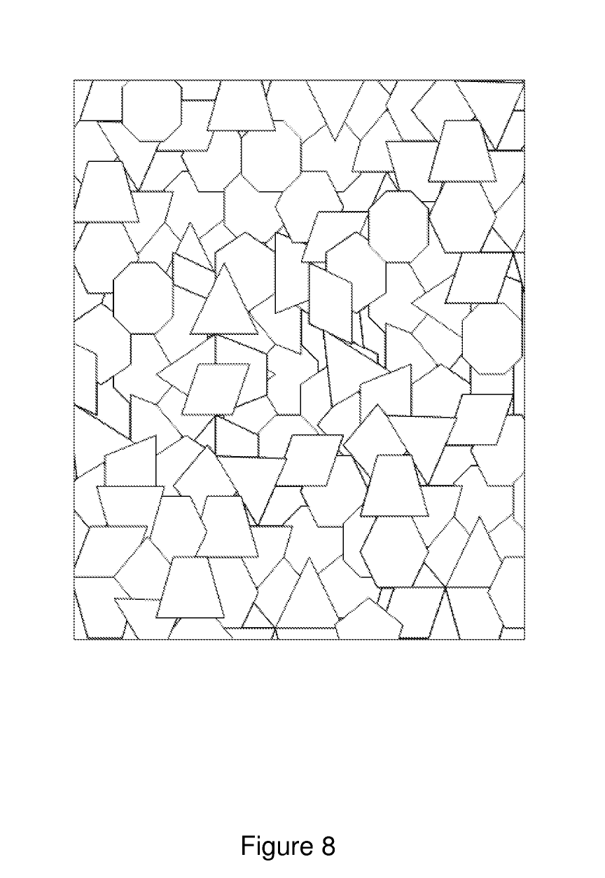

FIG. 8 illustrates the concept of random shapes for random grid arrangements.

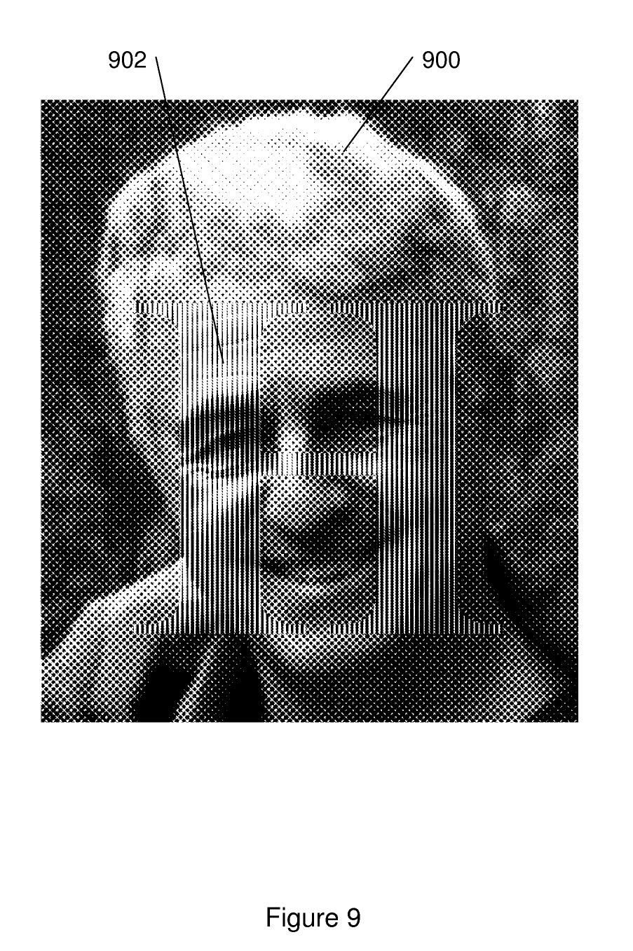

FIG. 9 illustrates modulation mixed-patterns designed to add additional dimension of visual elements in the graphical product.

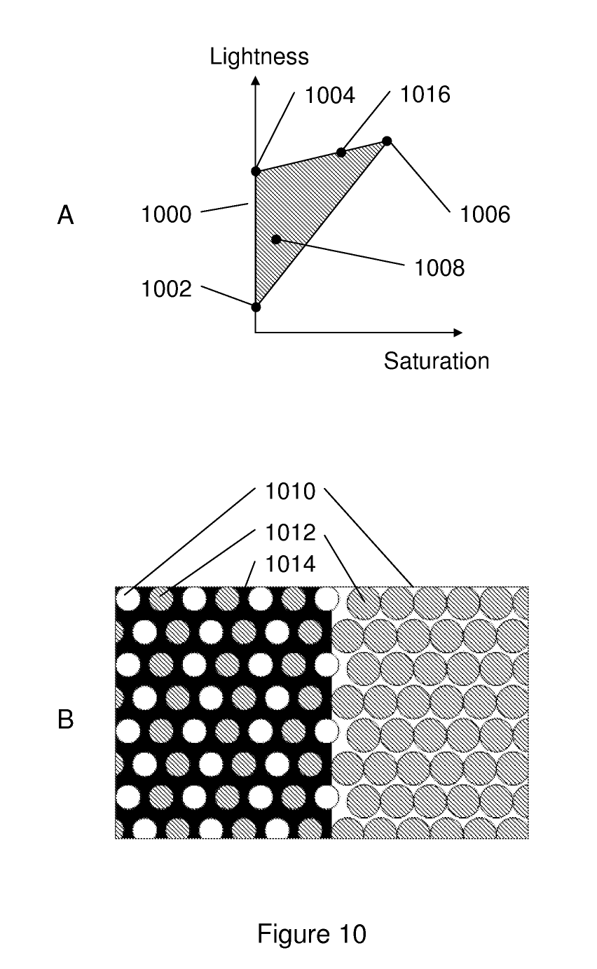

FIG. 10 illustrate a method of using at least 3 materials to generate perceived combinations of colors.

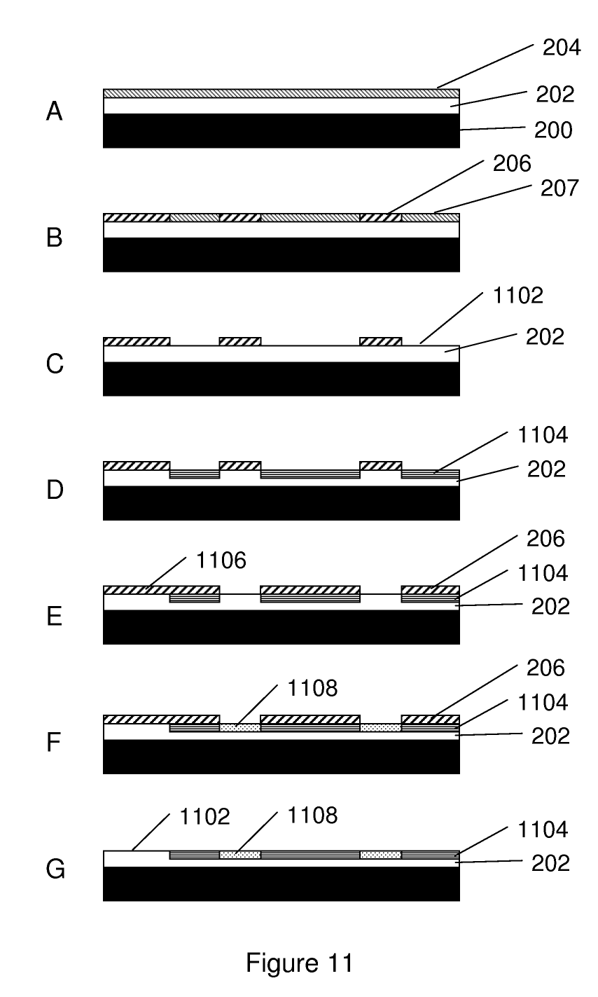

FIG. 11 illustrates one embodiment of the process to construct the color combinations using anodizing and coloring by dyes.

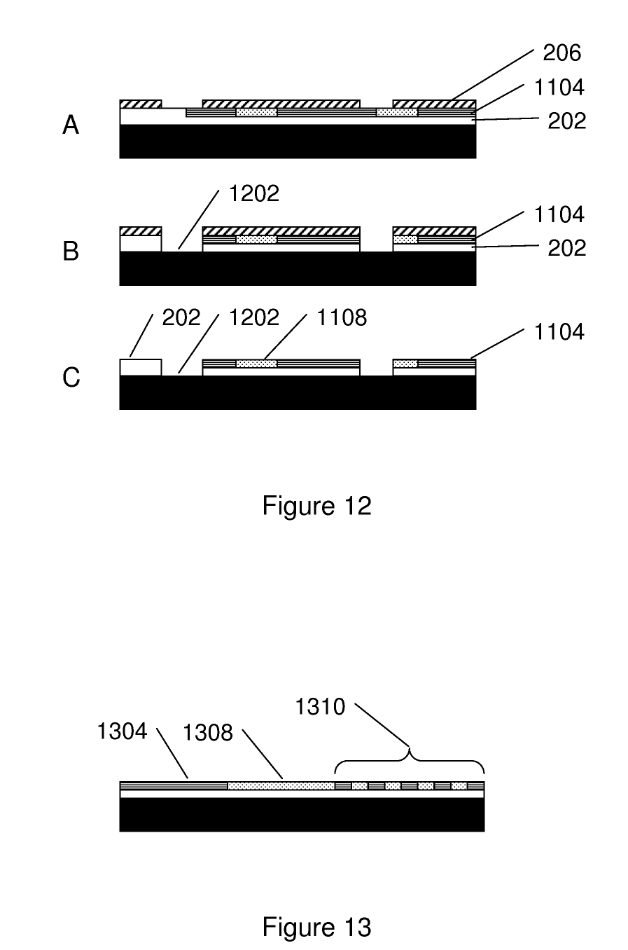

FIG. 12 illustrates adding the substrate color to the color gamut expended by the materials of FIG. 11.

FIG. 13 illustrates another way of combining colors to create other colors.

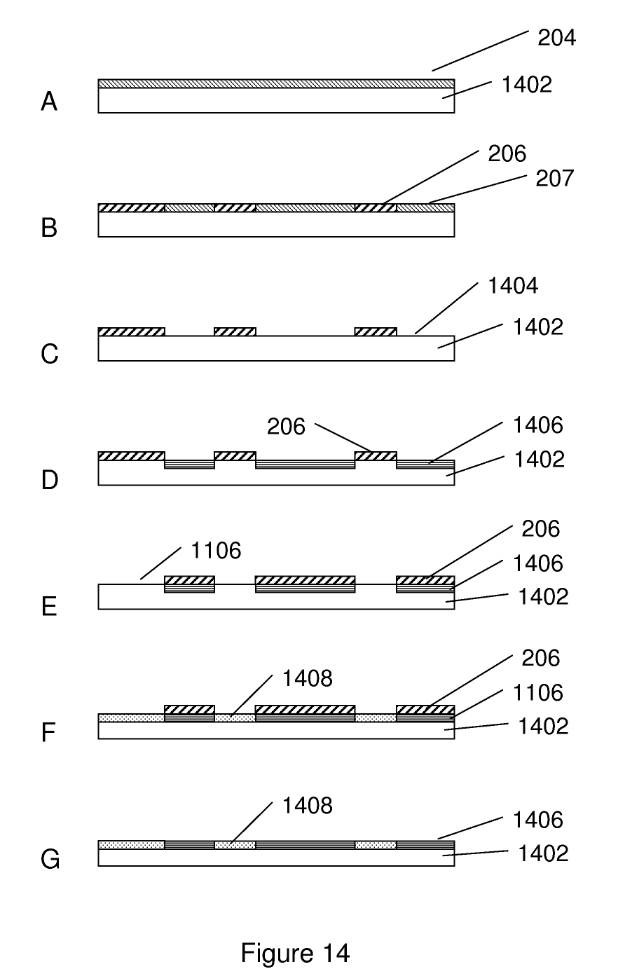

FIG. 14 illustrates the process to create colors by producing a very thin layers and use optical interference.

### A DETAILED DESCRIPTION OF THE INVENTION

Reference is made now to FIG. 1, which is a general description of one preferred embodiment of the invention. In this embodiment a portrait 100 of a person is impressed on the chip using aluminum layer over a silicon substrate. 102 is an enlargement of the right eyebrow section, showing details of the modulation of the aluminum layer 104 over the silicon layer 106.

In this configuration the aluminum layer (represented by the white areas 104) is brighter then the silicon layer (represented by the dark areas 106).

In an example of 0.6 μm CMOS production technology of semiconductors, the complete height of image 100 is constructed of 1,000 pixels of 0.6 μm resulting in actual physical size of 0.6 mm. The center to center distance between two dark points is 12 pixels, that is 12×0.6 μm=7.2 μm. This design is therefore based on a right-angle grid of rectangles which are 12×12 pixels. Each such 12×12 pixels cell is configured to be partially covered with aluminum and partially display the exposed underlying silicon. The mix of the area of the aluminum and the exposed silicon in such a cell determines the perceived gray level of this cell, the brightest gray level is that of the aluminum and the darkest gray level is that of the silicon. To produce a radiometric middle level of gray, half of the area is covered with aluminum and half of the area constitutes exposed silicon. Those skilled in the art would appreciate that human perceived gray level is not a linear function of radiometric values. Adjustment made for human observers are well known in the art and will not be discussed here.

One method of generating the desired partition between the aluminum and silicon areas in 12×12 pixels cells from a photographic image follows these steps:
1. Measure the radiometric value of a completely dark area in the photograph: I_{d}.
2. Measure the radiometric value of a completely white area in the photograph: I_{w}.
3. For a selected 12×12 cell, measure the average radiometric value of the same 12×12 area in the photographic image In.
4. Calculate the relative area of the aluminum layer in the selected 12×12 pixel area as follows: Aₐₗᵤₘᵢₙᵤₘ=In/(I_{w}−I_{d}).
   The geometrical pattern dividing the 12×12 pixels area between the aluminum layer and the exposed silicon can be determined in any desired way. In the example of FIG. 1, the exposed silicon is determined by creating a round hole 106 in the aluminum layer 104, whereas the hole is centered in the 12×12 pixels area and the area of the hole is 1−Aₐₗᵤₘᵢₙᵤₘ.

It would be appreciated that the geometrical role of the aluminum and the silicon can be reversed as shown in 108 where the aluminum assumes the round shape centered in the 12×12 pixels area. It is appreciated that the specific shape of the modulation can assume unlimited number of geometries and the specific geometry is not a limitation of the invention.

In the example of FIG. 1 the aluminum layer 104 is represented by the white color of the paper and the dark color of the exposed silicon is represented by the black color of the ink. It would be appreciated by those skilled in the art that aluminum on a microelectronic wafer is darker then the white of the paper and the exposed silicon is brighter then the black ink. If, in a linear radiometric scale of 0-100 the black of the ink is represented by 0 and the white of the paper by 100 then the aluminum will be about 75 and the silicon will be about 50. It should be appreciated that these values are estimated and provided here only for the purpose of illustration and do not limit the invention in any way. It would be appreciated also, that the apparent contrast of the image made with the aluminum and silicon colors is of a considerable lower contrast then the image made with ink on paper. This provides a lower quality image but nevertheless a clear perception of the image by human observers is enabled.

Being a miniature image, the image of the example above can not be perceived by the naked eye. A magnifying glass can be used to see the image. For example, a portrait as in the example of FIG. 1, made to the size of 2 mm×1.5 mm can be easily observed using a positive lens of 20 mm focal length.

As a rule of thumb that can be applied to the above method as well as to methods of spatially mixing two or more colors to provide a perceived impression of a color different from the used colors, one can consider angular resolution of 0.006 degrees for the angle spanned by a cycle size of the image mesh patter to the distance of the observer. With this angle (or smaller) the typical observer can not distinguish anymore the mesh structures and he perceives smooth area of the average gray scale or combined colors.

Reference is made now to FIG. 2 describing one preferred embodiment of the layers structures and the production of the image of FIG. 1 by modulation of the aluminum layer.

FIG. 2A is a cross section of the silicon wafer 200 providing the substrate holding the entire structure of the image and also providing the dark color layer of the image. Such wafers are available from the microelectronics industry at typical diameters of 150 mm to 300 mm in diameter and thickness of 675 μm-775 μm. Other sizes and thickness are also available. Final thickness can be adjusted using microelectronics processing methods. FIG. 2B is a cross section of silicon wafer 200 with an added thin layer of aluminum 202. Layer 202 can be deposited on the silicon using a variety of methods. One such method common in the industry of semi-conductor manufacturing deposits aluminum thin layer over a Si substrate wafer. In this method sputtered atoms that are ejected into the gas phase are not in their thermodynamic equilibrium state, and tend to deposit on all surfaces in the vacuum chamber. A substrate (such as a wafer) placed in the chamber will be coated with a thin film.

To modulate the aluminum layer, a photoresist layer 204 is placed on top of the aluminum layer 202 as shown in FIG. 2C. The photoresist might be placed using spinning methods and materials common in the field of semi-conductor production. Information on photoresists and their best mode of usage can be provided from MicroChem Corp. (MCC) of Newton, Mass., USA (www.microchem.com).

In FIG. 2D photoresist layer 204 is exposed to suitable light that induces chemical changes in the photoresist layer according to the desired modulation pattern. This exposure is typically made through a glass mask, allowing light exposure only in the desired areas. Following the exposure the photoresist comprises chemically two different areas 206 and 207 according to which area was exposed to light and which area was not exposed to light.

The photoresist is then processed chemically to wash-off the photoresist areas indicated with numerical reference 207, only the areas indicated 206 stay on top of the aluminum layer as shown in FIG. 2E. Aluminum area that was under photoresist area 207 is now exposed.

In the next stem the wafer is treated with aluminum etching material to remove the exposed aluminum layer. The aluminum layer under photoresist area 206 is protected from the etching material and therefore is not removed from the wafer during this etching process. The result of this etching is demonstrated in FIG. 2F.

A variety of etching processes is available, including wet etching or plasma etching, where in the last example, carbon tetrachloride (CCl₄) can be used to etch aluminum and silicon. These methods are commonly exercised in the field of microelectronics production.

Following the step of etching off the undesired aluminum areas, photoresist 206 is removed to provide the result of FIG. 2G, a spatially modulated bright thin aluminum layer over a dark Si layer.

In yet another embodiment of the invention, the product of FIG. 2G, modulated to produce an image as explained in FIG. 1, can be coated with a protective layer to ensure its' resistance to environmental conditions. Such a protective layer is shown in FIG. 3, indicated by numerical reference 300. This layer covers both the aluminum 202 layer and the surface of silicon substrate 200.

One such layer 300 can be constructed by sputtering silicon dioxide molecules to provide a layer of silicon dioxide, also known as silica, a chemical formula of SiO₂ that has been known for its hardness since antiquity. Also silicon nitride can be used to produce the protective layer. Both silicon dioxide and silicon nitride provide well transparent layers in thicknesses under 100 μm to enable a clear visibility of the image of FIG. 1 while, at the same time, provide excellent protection from environmental materials that might damage the image.

It would also be appreciated that the invention is not limited to the example of layers constituting different heights as shown in FIG. 2. In another example, shown in FIG. 4A, pits 402 can be etched into the silicon substrate 200 as shown in FIG. 4B. Then, as shown if FIG. 4C, an aluminum layer 202 is sputtered over the whole area, covering the whole surface of silicon substrate 200. The aluminum layer side is now polished to remove the high areas 404 of the aluminum until the silicon is exposed as shown in FIG. 4D. In this example the silicon surface and the aluminum surface are of the same height.

FIG. 4E is provided for comparison with FIG. 4D to show the same modulation pattern in both figures but with different surface height modulation, where in the example of FIG. 4D there is no surface height modulation.

It would be appreciated that different materials can be used in the construction of the image. For example, gold can provide the gold yellowish impression comparing to the gray impression of aluminum. Copper can be used to provide the color of the copper layer. Annealing can be used to control the surface roughness (and therefore its reflectivity) to provide different visual impressions.

Multiple layers can be used for provide more than two colors such as dark gray silicon substrate, light gray of an aluminum layer and yellowish color of a gold layer. Multiple layers are produced using methods such as described in reference to FIG. 2, using well-established processes such as those available in the microelectronics industry.

Characteristics of a repeatable pattern of FIG. 1 made with highly reflective aluminum layer and lower reflective silicon substrate includes light interference that generates color patterns on the image surface, the light color depend on the angle of view. This will be better understood in reference to FIG. 5, where the construction of image 500 in made using a geometry of vertical interchangeable lines of silicon underlying substrate 106 and aluminum overlaying lines 104, which centers are uniformly spaced along the horizontal axis as shown in the enlarged section 502.

This structure constitutes what is known in optics as optical-grid. Such structures are designed in the field of optics to selectively reflect specific light wave-lengths in a predetermined direction, depending on the wavelength, the angle of incident light and the distances between the lines.

This interference phenomena is also evident in the pattern of FIG. 1 but the characteristics of the interference is more complicated due to the 2-dimensional geometry of the grid of FIG. 1 comparing to the 1-dimensional geometry of the grid of FIG. 5. The color interference might be a desired feature to add some color impressions to the image. Yet, in some cases this interference is undesired and uniform color impression over the image area and view angles is desired.

FIG. 6 illustrates a uniform gray area that is created with a uniform horizontal and vertical grid. The horizontal grid geometry of the aluminum layer is demonstrated by lines 602. The vertical grid geometry of the aluminum layer is demonstrated by lines 604. Each of these structures is operative, over a relatively large area, to provide the perceived interference colors.

A special implementation of the current invention removes this interference from being visible by a human observer by breaking the grid repeatable geometry to small grid elements, each one provides a different interference colors for a given angle of incident light and angle of observation. As shown in reference to FIG. 7, doted rectangle 700 represents the same uniform gray area of FIG. 6. In FIG. 7 however, the large area was divided to many small areas such as emphasized areas 702 and 707. In each of the small areas the direction of the grid is selected arbitrarily as shown by reference lines 706 and 708, demonstrating different grid angles for areas 702 and 704. The shape of each area is generated randomly or is randomly selected form a collection of predetermined shapes.

Also the angles can be generated randomly or from a predetermined set of angles. The small areas are preferably not arranged on an ordered grid but are distributed randomly, with preferably random selection of positions, whereas the range of distances is bounded according to a preferred statistical function.

For example, a collection of 20 shapes may be created. For each shape the area of the shape is fixed to a predetermined area (with a range of statistically allowed deviations—if desired). A center of gravity is calculated for each shape. The image area is mapped with pivot-points on a 2-dimensional vertical/horizontal grid, the vertical/horizontal distance between the pivot-points is equal to ½ of the square rout of the shape area.

Now, to divide the image to grid areas, for each pivot point a shape is selected randomly out of the 25 shapes collection. Then, for the given pivot point, a random selection of center point is generated using the rule of uniform distance distribution from the pivot point, the distribution is limited for minimum distance 0 and maximum distance ¼ of the square rout of the shape area. The angle between the pivot point and the center point is selected randomly from the range of angles 0-360 degrees with a uniform distribution. Once the center point has been randomly calculated as described above, the selected shape is positioned on the image with the center of gravity coinciding with the center point.

When a currently positioned shape covers a part of a previously shape, the borders of the currently positioned shape overlay the previous shape and constitute this new section of the border of the previous shape.

This procedure is repeated for all the pivot-points of the grid. Also the order of selecting pivot points can be random, for example, next point is selected randomly form the list of pivot points that were not selected before.

The algorithm of generating this random area division may also use random rotation of the selected shape prior to positioning it on the image with the center of gravity coinciding with the center point.

It would be appreciated by those skilled in the art that the process of generating geometrical differences in sub-areas of the image can also use a pre-determined design of geometrical parameters and using random process is not compulsory. The geometrical parameters can be pre-designed for all sub-areas of the image.

An example result of dividing the image area as described above is provided in FIG. 8. For each area, a modulation of the aluminum layer is made as described in reference to FIG. 1 above, except that the angle of the grid pattern is selected randomly, in this example using uniform distribution in the range 0-90 degrees. The example such as illustrated in FIG. 7 is thus generated.

It would be appreciated that not only the angle of the modulation grid can be changed but also the density of the grid, since interference angles depend also on the grid density. In a typical implementation, the size of a grid cell might be 6 pixels (3.6 μm in case of 0.6 μm production technology and the area of a shape might be 40 μm². This can provide randomly changing interference pattern of a typical size of 20 μm that, for a human observer using ×10 magnifying glass will provide the impression of a uniform colored (or gray) area, without being able to distinguish the interference color patterns.

In another embodiment of the invention, the grid interference characteristics of the invention can be used to generate the desired color effects. For example, the method of FIG. 5 can be used to induce colors to the image, colors that vary with the angle of incident light and the angle of view. The rate of change of these colors per change in the angle of incident light or angle of view may be controlled by the density of the grid lines, a practice that is well known and widely used in optical design.

FIG. 9 illustrates another embodiment of using the optical characteristics of the grid geometry to provide the impression of the letter H over the image. Most of the image modulation 900 is made of circular points arranged on a uniform 2-dimensional grid at 45 degrees. Area 902 is modulated using a 1-dimensional grid with vertical lines. As a result, per the angle of incident light and the angle of view, area 902 will exhibit a color which is different than area 900 and thus will be visible to the observer that can not actually resolve the modulation patterns of either area 900 or area 902 but can see the color differences between these areas.

In yet another embodiment of the invention, a mixture of more than 2 layers (i.e. silicon substrate and aluminum layer) can be combined to provide additional span of color affects. For example, a gold layer might be added to provide a third color to the image and a mixture of all colors. For example, all shades of colors ranging from gray of the aluminum to yellow of the gold may be generated by mixing areas of aluminum and gold. This is explained better in FIG. 10A, showing a lightness/saturation color space, where the color gamut (as commonly used in color science) is described by the dashed area 1000. All the colors of area 1000 can be generated by combinations of the silicon (numerical indicator 1002), the aluminum (numerical indicator 1004) and gold (numerical indicator 1006).

FIG. 10B demonstrates one implementation of such 3 layers. The color point 1008 of FIG. 10A is generated in the example of FIG. 10B (left side) by alternative aluminum points 1010 and gold points 1012 over the silicon substrate 1014. Color point 1016 of FIG. 10A is generated in the example of FIG. 10B (right side) by gold points 1012 and aluminum background 10110.

The areas of the 3 colors (silicon, aluminum and gold) are typically designed with prorated area according to the distance of the desired point from points 1002, 1004 and 1006. For example, having silicon color as the substrate and default color and using a gamut representation of FIG. 10A can support the following method for translating a point in the diagram of FIG. 10A to relative area of aluminum and gold (in this example). Given the coordinates of the 3 basic color points 1002, 1004 and 1006 in this SL (Saturation, Lightness) plan, where a point vector is defined by:
1002: (A1=0,A2)
1004: (S1=0,S2)
1006: (G1,G2)
   Where A1, S1 and G1 represent the saturation values of Aluminum, Silicon and Gold respectively (A1 and S1 equal zero since their saturation is zero in this example) while A2, S2 and G2 represent the lightness values of Aluminum, Silicon and Gold respectively, and the relative areas of the silicon, aluminum and gold are given respectively by As, Aa and Ag, the relative area of aluminum and gold for a general point (P1,P2) such as 1008 is given by the equations:

P1=A1·Aa+S1·As+G1·Ag

P2=A2·Aa+S2·As+G2·Ag

Aa+As+Ag=1

Given desired P1 and P2, the relative areas Aa, As and Ag can be calculated.

It would be appreciated by those skilled in the art that the representation of the color space of FIG. 10A is made in application specific coordinates that normalizes the silicon color 1004 and aluminum color 1002 to completely unsaturated colors (saturation=0) and the color of the gold (or cupper or any other selected material) 1006 is represented as a color with saturation>0 and also lightness value higher than that of the aluminum. Although perceptual color spaces are generally described by many standard color spaces such as HSL and HSV, the description above is simplified to present the concepts and methods while those skilled in the art of color transformations can easily apply the above concepts and methods to any color space they prefer to work with.

In yet another embodiment of the invention, the modulation of the surface is made with colors, using anodizing and anodizing colorant materials. Anodizing, an electrolytic passivation process used to increase the thickness of the natural oxide layer on the surface of a variety of metals.

In the example of pure aluminum surface when exposed to air at room temperature, or any other gas containing oxygen, pure aluminum self-passivates by forming a surface layer of amorphous aluminum oxide 2 to 3 nm thick. Aluminum alloys may. The anodizing process is well known in the art and will not be described here. Methods and techniques are available from many sources, one such source is “Anodizing and Coloring of Aluminum Alloys” by S. Kawai, published in 2002 by Asm Intl, ISBN-10: 090447724X, ISBN-13: 9780904477245.

Aluminum anodizing is usually performed in an acid solution which slowly dissolves the aluminum oxide. The acid action is balanced with the oxidation rate to form a coating with nanopores, 10-150 nm in diameter. These pores are often filled with colored dyes before sealing to provide the anodized aluminum with the desired color. A practically unlimited number of colors are available.

A relatively shallow anodizing is preferred for this process to support both higher spatial resolution of the modulation and relatively bright and saturated colors. Deep anodizing would generally result with nearly black colors and lower special resolution. The film thickness can range from under 0.5 μm for bright decorative work up to 150 μm for architectural applications. The range of under 0.5 μm would generally support the preferred color vividness desired for this invention, to generate color images through colorant modulations on the aluminum anodized layer.

In the current invention, the substrate for this image might be a silicon wafer but also an aluminum plate. The process will be described in reference to a silicon substrate.

FIG. 11 illustrates the coloring process of a silicon wafer coated with aluminum layer, in this example 3 colors are demonstrated.

FIG. 11A is the equivalent stage of FIG. 2C. Silicon substrate 200 is coated with aluminum layer 202, preferable in the order of about 0.3-1 μm and on top a photoresist layer 204. At the stage of FIG. 11A the aluminum is already past the anodize process that creates the surface micropores used for coloring by filling them up with the desired colorant.

In FIG. 11B photoresist 2004 was exposed to the modulation pattern to create the hardened sections 206. After processing of the photoresist we get the stage of FIG. 11C where anodized aluminum sections 1102 are exposed and reedy for the coloring process with a selected “dye1”. The result of coloring is illustrated in FIG. 11D where colorized areas are denoted by numerical reference 1104.

A second photoresist coating is applied, exposed through a modulation mask and processed to produce the structure illustrated in FIG. 11E. No the remaining photoresist covers both previously colored areas and also aluminum uncolored areas that are not to be colored at this stage (see numerical reference 1106). A second coloring process is used to apply “dye2” an results in the illustrated structure of FIG. 11F, “dye2” is indicated by numerical reference 1108. In FIG. 11G the photoresist is completely removed and the surface of the structure presents 3 colors: “dyw1”, “dye2” and the color of aluminum. Another process that can be added to enhance the result illustrated in FIG. 11 is adding the color of the silicon substrate by etching through the anodized aluminum using a modulated photoresist. This is illustrated in FIG. 12. FIG. 12A illustrates the already partially dyed aluminum layer with a modulated and processed photoresist layer 206 with two openings in the photoresist layer. Etching the aluminum in the photoresist area exposes the silicon layer as shown in FIG. 12B by numerical reference 1202. In FIG. 12C the hardened photoresist is removed to result with a 4-color modulated surface. Aluminum (202), silicon (1202), dye1 (1104) and dye2 (1108). It would be appreciated that this extra step is not possible if the substrate layer is the aluminum itself, which might now be typically in the thickness of few tens of a millimeter.

Another alternative for the process sequence of FIG. 11 is to use the anodize process for each colorant separately, just before the coloring stage, per colorant. By doing so the photoresist is applied on a smooth aluminum surface, a procedure that makes it easier to process and remove photoresist that is modulated at a high spatial frequency comparing to handling photoresist over an etched area. This process naturally results in more processing stages and would by typically more expensive but, on the other hand, produce finer results. The selection of the preferred method depends on cost and results considerations and might vary per application.

It would be appreciated by those skilled in the art that the process of FIG. 11 can be repeated again and again to allow for any number of desired colors. Thus, a miniature image or any graphic element may be constructed of as many colors as desired with infinite modulation geometries. This opens the gate for plenty of applications including unit-counterfitting, bar-coding-like applications etc.

Any of the above processes can be followed by a sealing layer as common in the anodizing industry.

In another preferred embodiment of the invention the number of colors used to generate a variety of colors in the image is lower than the apparent variety of colors. By using a small collection of colors to create a larger number of colors, less layers processes are used and the cost of the production process is lower. This is explain in reference to FIG. 13 which is a special mode of the process of FIG. 11.

In this example 2 color dyes are used: red dye (1304) and green dye (1308). Arias 1104 and 1108 are relatively large therefore result in red and green color perception, respectively, by the observer. Area 1310 however is constructed from smaller geometries of evenly mixed red and green colors, the size of these geometrical elements are smaller than the observer's eye resolution. This is made in methods similar to the described in reference to FIG. 10B. As a result the combined red and green colors are perceived by the observer as a third color—yellow. All hues between red to green, through yellow, can be generated by different area mixture of the red and green area of section 1310 of FIG. 13.

Additional “color components” can be used to provide more colors but also more color geometrical mixtures to provide hues un-available by any of the individual dyes. The concept of such mixtures of colors are available using the theories of color science as described briefly in reference to FIG. 10A.

Interference through thin layers (or thin films) is well known in optical science and is also known to many laymen exposed to the explanation of the wonderful colors of a thin oil layer over a water paddle on the street.

Light reflected from the first surface of the thin layer interferes with light reflected from the second surface of the thin later. When the layer thickness is considerably thinner then the coherence length of the light source, clear and vivid colors of constructive interference show up while other colors are suppressed through a destructive interference. This phenomenon is widely used in optics to produce dichroic filters, coat lenses and even coat spectacles with ant-reflective coating. The physics of this phenomena is well known and described in many sources, including “Seeing the Light” by David Falk, Dieter Brill and David Stork, Published 1986 by John Wiley & Sons, ISBN 0-471-60385-6.

To perform well the thin layer first and second surfaces must be of reflection properties that reasonably balance the reflection from the first surface and the reflection from the second surface (including multiple such reflections). These considerations are well known by those skilled in the art and the theory and materials involved are widely in use.

In reference to the present invention a preferred embodiment makes use of anodized titanium. The color formed is dependent on the thickness of the oxide (which is determined by the anodizing voltage). It is caused by the interference of light reflecting off the oxide surface with light traveling through it and reflecting off the underlying metal surface.

Anodized titanium is used in a recent generation of dental implants. An anodized oxide layer has a thickness in the range of 50 to 100 nanometers, much thicker than that for a naturally formed oxide layer, which has a range of 5 to 25 nanometers. Anodized titanium can reach thickness of about 300 nm. By covering reasonably the desired range the range of λ/2 (λ: wave length) in the visible range, i.e. thickness range of 200-350 nm

Using the good interference properties of titanium anodized layer, anodizing titanium generates an array of different colors without dyes. Titanium nitride coatings can also be formed, which have a brown or golden color.

The use of anodized titanium, like aluminum, can be used both by depositing a titanium layer over a silicon wafer (see example method: “CHEMICAL VAPOR DEPOSITION OF TITANIUM ON A WAFER COMPRISING AN IN-SITU PRECLEANING STEP”, International Patent Application No.: PCT/US1998/023740 by SRINIVAS, Ramanujapuram, A. et. al., International Filing Date: Jun. 11, 1998) or by using a titanium wafer, i.e. thin plates (see example “Development of Metal Wafers and Nanoflat Metals of Very Thin Titanium or Other Metal Sheets by Advanced Polishing Technology”, author: ISOZAKI CHUZO, Journal Title: Titanium Japan, Journal Code: G0043A, ISSN: 1341-1713, VOL. 54; No. 4; PAGE. 265-269; Year: 2006) or titanium plates. Titanium anodizing is provided by many suppliers such as Titanium Finishing Company, 248 Main St., East Greenville, Pa. 18041.

FIG. 14 illustrates the process of modulated anodizing of titanium, being a method useful, for example, for generation of color complex graphics on a miniature scale on titanium.

FIG. 14A illustrates a titanium substrate 1402 with photoresist coating layer 204. In FIG. 14B photoresist layer 206 is exposed through a modulated mask to generate hardened areas 206 and soft areas 207. FIG. 14C illustrates the post photoresist processing stage where areas of titanium 1402 are protected by the hardened photoresist 206 while other areas of the titanium (1304) are exposed for the anodizing procedure. The titanium plate is going now trough an anodizing process to create the anodized titanium thickness as required for desired “color1”. The result is illustrated in FIG. 14D where area 1406 carries now the desired “color1”. Photo resist 206 is now washed away and a new photoresist layer is applied, exposed through modulation mask and developed to provide the structure illustrated in FIG. 14E. This structure goes to a second stage of anodizing to build the anodize layer 1408 of FIG. 14F, to produce “color2”. Photoresist 206 is washed away now to provide the 2-color modulated result of FIG. 14G. As many colors as desired can be generated by repeating the layers process any number of times as required.

It would be appreciated that it is not required to process each area completely independent of other areas as described above. It is possible to anodize area A in a first stage and then anodize area A again when anodizing area B. As a result the thickness of area A will be larger than the thickness of area B and two different colors will be created. This second option does not reduce the stages of the processing yet it bundles the thickness of one area with the thickness of another area, resulting in less thickness flexibility and this, color selection flexibility.

It would be appreciated, by those skilled in the art, that also for the method described in reference to FIG. 14 many colors can be generated for a visible observer by using fewer colors, as described in reference to FIG. 13.

It would also be appreciated by those skilled in the art that the modulation design using the herein above described methods and technologies can be made to generate text, in particularly miniature text. For example, a font might be smaller then 1.5 μm. The complete text of the bible can be modulated using the above techniques on an area smaller then 20 mm². Combining the above described technologies, such as metal layers, anodizing and dyeing provides for variety of colors for such text. Text and graphic elements, including pictures can be combined to provide complex graphic art products on miniature surfaces with great environmental durability characteristics.

It would also be appreciated by those skilled in the art that the above described methods and technologies can be combined on a single graphic unit to exercise the benefits available from different technologies.

For example, optical grid pattern 902 of FIG. 9 can be generated in combination with the coloring method of FIG. 11.

It would also be appreciated by those skilled in the art that the above described methods and technologies are not limited to the materials mentioned herein above as examples and sequences of processing steps described herein above. These are provided as examples and other materials and sequences of processing steps can be used to optimize final result, depends on the specific design and the set of technologies implemented in the production of the design.

The herein above embodiments are described in a way of example only and do not specify a limited the scope of the invention.

The scope of the invention is defined solely by the claims provided herein below:

1. A device for displaying a 2 dimensional object comprising
a substrate of a first material having a first color;
a layer of a second material having a second color;
said second material is deposited on said first material;
said second martial is modulated so that first and second materials are visible to an observer; and
the relative exposed area of said first material and relative exposed area of said second material, in a given area of the device, are designed to provide a pre-determined color generally in between the colors of said first and second materials.

2. The device according to claim 1 whereas said modulation geometry is designed to produce colors through light interference created by light interaction with said modulated modulation.

3. The device according to claim 1 whereas at least one geometrical parameter of said modulation is different for at least one sub-area of the device from the same parameter of said modulation for at least one another sub-area of said device.

4. The device according to claim 1 whereas more than 2 materials are used to constitute the color gamut of said device.

5. The device according to claim 1 whereas at least one geometrical parameter of the modulation is determined to change randomly throughout at least one sub-area of the device.

6. The device according to claim 1 whereas
At least one of said materials is metal; and
color is added to said metal surface by anodizing the metal layer and adding dye in a modulated pattern.

7. The device according to claim 6 whereas said substrate material is metal and the modulation is made on the surface of this material.

8. A device for displaying a 2 dimensional object comprising:
a substrate of a first material;
said material is characterized by thin layer anodizing in at least a part of the range above 200 nm;
said anodize layer has reflection characteristics of external and internal surfaces suitable for interference between light reflected from said external surface and light reflected from said internal surface; and
the thickness of said anodize layer is spatially modulated to generate said 2 dimensional object.

9. The device according to claim 8 whereas at least a part of said spatial modulation comprises at least one of the following
a. spatial geometry of text; and
b. spatial geometry of line art.

10. The device according to claim 9 whereas at least 2 thicknesses are used to generate at least three colors through at least three different geometrical mix of modulation thicknesses.

11. The device according to claim 10 whereas at least a part of said spatial modulation comprises an image.

12. The device according to claim 11 whereas at least a part of said spatial modulation comprises at least two of:
a. Text;
b. Line art;
c. Image;
d. photograph;
e. drawing; and
f. Painting.

13. The device of claim 1 whereas at least a part of the modulation cycles size and the distance to observer's eye are designed to expanse an angle below 0.01 degrees.

14. The device of claim 8 whereas at least a part of the modulation cycles size and the distance to observer's eye are designed to expanse an angle below 0.01 degrees.

15. The device according to claims 1 whereas the internal surface of said second material is deposited below the external surface of the first material and both first and second materials external surfaces are leveled at the same plan.

16. The device according to claim 1 whereas the external surfaces of said first and second materials are coated with additional material.

17. A device for displaying a 2 dimensional object comprising
a substrate of a first material having a first color;
a layer of a second material having a second color;
said second material is deposited on said first material;
said second martial is modulated so that first and second materials are visible to an observer;
the relative exposed area of said first material and relative exposed area of said second material, in a given area of the device, are designed to provide a pre-determined color generally in between the colors of said first and second materials;
said modulation geometry is designed to produce colors through light interference created by light interaction with said modulated modulation; and
at least a part of said spatial modulation comprises at least one of:
a. text;
b. line art;
c. image;
d. photograph;
e. drawing; and
f. painting.

18. The device according to claim 17 whereas more than 2 materials are used to constitute the color gamut of said device.

19. The device according to claim 17 whereas the external surfaces of said first and second materials are coated with additional material.

20. The device of claim 17 whereas at least a part of the modulation cycles size and the distance to observer's eye are designed to expanse an angle below 0.01 degrees.
